(19) United States
(12) Patent Application Publication
(10) Pub. No.: US 2013/0301238 A1
(43) Pub. Date: Nov. 14, 2013

(54) LUMINAIRE HAVING A VENTED ENCLOSURE

(71) Applicant: LIGHTING SCIENCE GROUP CORPORATION, Satellite Beach, FL (US)

(72) Inventors: Mark Penley Boomgaarden, Satellite Beach, FL (US); Eric Holland, Indian Harbour Beach, FL (US); Rick LeClair, Melbourne, FL (US)

(73) Assignee: LIGHTING SCIENCE GROUP CORPORATION, Satellite Beach, FL (US)

(21) Appl. No.: 13/875,855

(22) Filed: May 2, 2013

Related U.S. Application Data
(60) Provisional application No. 61/642,257, filed on May 3, 2012.

(51) Int. Cl. F21V 29/02; F21V 29/00

(52) U.S. Cl. CPC F21V 29/02; F21V 29/22
USPC 362/95

(57) ABSTRACT

A lighting device may include an electrical base and an enclosure which may include one or more vents. An intermediate member may be positioned between the electrical base and the enclosure. A light source may be positioned adjacent to the intermediate member to be enclosed by the enclosure and also positioned in electrical communication with the electrical base. A controller may be carried by the intermediate member and also positioned in electrical communication with the electrical base. A driver circuit may be carried by the intermediate member and also positioned in electrical communication with the electrical base. The vents may be configured to permit the flow of fluid through an interior portion of the enclosure so that the light source is in thermal communication with the fluid flow.

### RELATED APPLICATIONS

This application is a continuation (and claims the benefit of priority under 35 USC 120) of U.S. Provisional Patent Application No. 61642257, filed May 3, 2012. The disclosure of the prior application is considered part of (and is incorporated by reference in) the disclosure of this application.

### FIELD OF THE INVENTION

The present invention relates to the field of lighting devices and, more specifically, to cooling systems for lighting devices that allow a heated fluid to be directed away from a heat source.

### BACKGROUND OF THE INVENTION

As electronic devices operate, they may generate heat. This especially holds true with electronic devices that involve passing an electrical current through a semiconductor. As the amount of current passed through the electronic device may increase, so may the heat generated from the current flow.

In a semiconductor device, if the heat generated from the device is relatively small, i.e., the current passed through the semiconductor is low, the generated heat may be effectively dissipated from the surface area provided by the semiconductor device. However, in applications wherein a higher current is passed through a semiconductor, the heat generated through operation of the semiconductor may be greater than its capacity to dissipate such heat. In these situations, the addition of a cooling device may be required to provide further heat dissipation capacity.

For example, one type of semiconductor device includes LED lamps. LED lamps may include a plurality of LEDs mounted to a circuit board, where current passes through the LEDs to produce light. The current, however, produces heat in addition to light. Excess heat may decrease efficiency and may, in fact, damage the LEDs. Heat helps to facilitate movement of dopants through the semiconductor, which may render the LED less powerful, or even useless. There are many ways to dissipate heat, including the surface area of the semiconductor itself, as well as heat sinks, but a need exists to dissipate heat faster while maintaining efficiency.

Two major types of cooling devices exist—active and passive. An active cooling device may require its own power draw to direct heat and heated fluids away from a heat source. A passive cooling device, however, may provide a pathway for heat and heated fluids to be directed away from a heat source. An active cooling device may, for instance, include a fan, while a passive cooling device may, for instance, be provided by a heat sink.

Typically, a heat sink may provide an increased surface area from which heat may be dissipated. This increased heat dissipation capacity may allow a semiconductor to operate at a higher electrical current. Traditionally, a heat sink may be enlarged to provide increased heat dissipation capacity. However, increasing power requirements of semiconductor based electronic systems may still produce more heat than may be capably dissipated from a connected heat sink alone. Furthermore, continued enlargement of the heat sink size may not be practical for some applications.

### SUMMARY OF THE INVENTION

With the foregoing in mind, the present invention is related to a luminaire having a venting system. The luminaire according to embodiments of the present invention advantageously allows for air to be circulated within an enclosure to provide cooling therein and to enhance life of the luminaire. The luminaire according to embodiments of the present invention also advantageously provides enhanced lighting effects while simultaneously providing enhanced efficiency with respect to cooling of the light source.

The lighting device may include an electrical base and an enclosure which includes one or more vents. An intermediate member may be positioned between the electrical base and the enclosure. A light source may be positioned adjacent to the intermediate member to be enclosed by the enclosure and also positioned in electrical communication with the electrical base. A controller may be carried by the intermediate member and also positioned in electrical communication with the electrical base. A driver circuit may be carried by the intermediate member and also positioned in electrical communication with the electrical base. The vents may be configured to permit the flow of fluid through an interior portion of the enclosure so that the light source is in thermal communication with the fluid flow.

The light source of the lighting device may be a plurality of lighting devices and/or a light-emitting diode. The one or more vents of the lighting device may be a plurality of vents that are symmetrically spaced around the circumference of the enclosure. The one or move vents may also be a single continuous vent that extends the circumference of the enclosure. The shape of the one or more vents may be an inverse “U”.

The lighting device may include a conversion layer that is applied to at least one of the light source, an interior surface of the enclosure and an exterior surface of the enclosure. The conversion layer may be a conversion phosphor, delay phosphor, or quantum dot.

The lighting device may further include a heat sink positioned adjacent the intermediate member. The intermediate member may connect the heat sink and the electrical base. In an alternative embodiment, the intermediate member may include a heat sink.

### BRIEF DESCRIPTION OF THE DRAWINGS

FIG. 1 is an elevation view of a luminaire according to an embodiment of the present invention.

FIG. 2 is a cross-sectional view of the luminaire illustrated in FIG. 1 taken through line 2-2 in FIG. 1.

FIG. 3 is a perspective view of the cross-sectional view illustrated in FIG. 2.

FIG. 4 is a top plan view of the luminaire illustrated in FIG. 1.

FIG. 5 is an elevation view of a luminaire according to another embodiment of the present invention.

FIG. 6 is a cross-sectional view of the luminaire illustrated in FIG. 5 taken through line 6-6 in FIG. 5.

FIG. 7 is a perspective view of the cross-sectional view illustrated in FIG. 6

FIG. 8 is a top plan view of the luminaire illustrated in FIG. 5.

FIG. 9 is an elevation view of a luminaire according to yet another embodiment of the present invention.

FIG. 10 is a cross-sectional view of the luminaire illustrated in FIG. 9 taken through line 10-10 in FIG. 9.

FIG. 11 is a top plan view of the luminaire illustrated in FIG. 9.

FIG. 12 is a bottom plan view of the luminaire illustrated in FIG. 9.

FIG. 13 is an elevation view of a luminaire according to still another embodiment of the present invention.

FIG. 14 is a cross-sectional view of the luminaire illustrated in FIG. 13 taken through line 14-14 in FIG. 13.

FIG. 15 is a top plan view of the luminaire illustrated in FIG. 13.

FIG. 16 is a bottom plan view of the luminaire illustrated in FIG. 13.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Additionally, in the following detailed description, reference may be made to the driving of light emitting diodes, or LEDs. A person of skill in the art will appreciate that the use of LEDs within this disclosure is not intended to be limited to the any specific form of LED, and should be read to apply to light emitting semiconductors in general. Accordingly, skilled artisans should not view the following disclosure as limited to the any particular light emitting semiconductor device, and should read the following disclosure broadly with respect to the same. Those skilled in the art will also appreciate that the terms luminaire and lighting device are interchangeably used throughout this disclosure and are meant to refer to the same structural items.

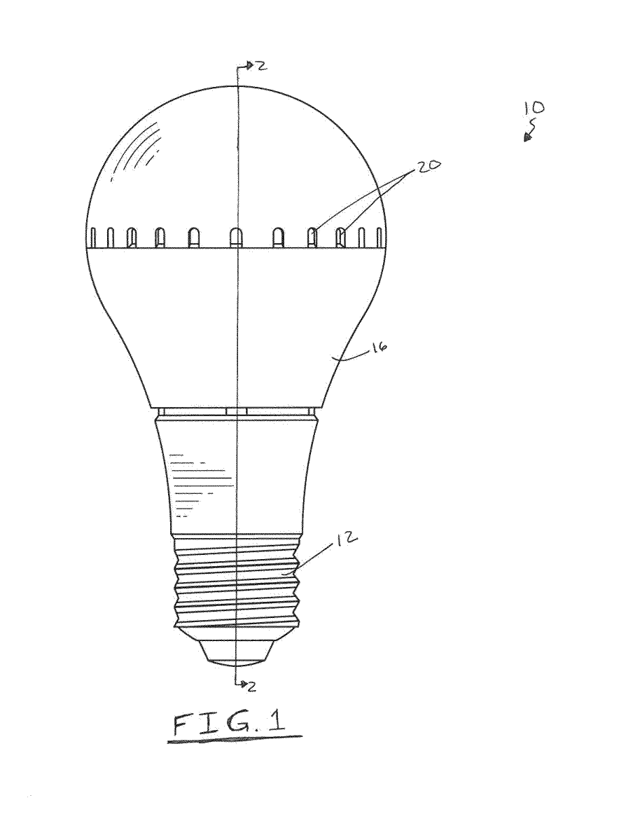

Referring now to FIGS. 1-16, a luminaire or lighting device 10 having a venting system will now be discussed. Referring now initially to FIGS. 1-4, one such embodiment will now be discussed.

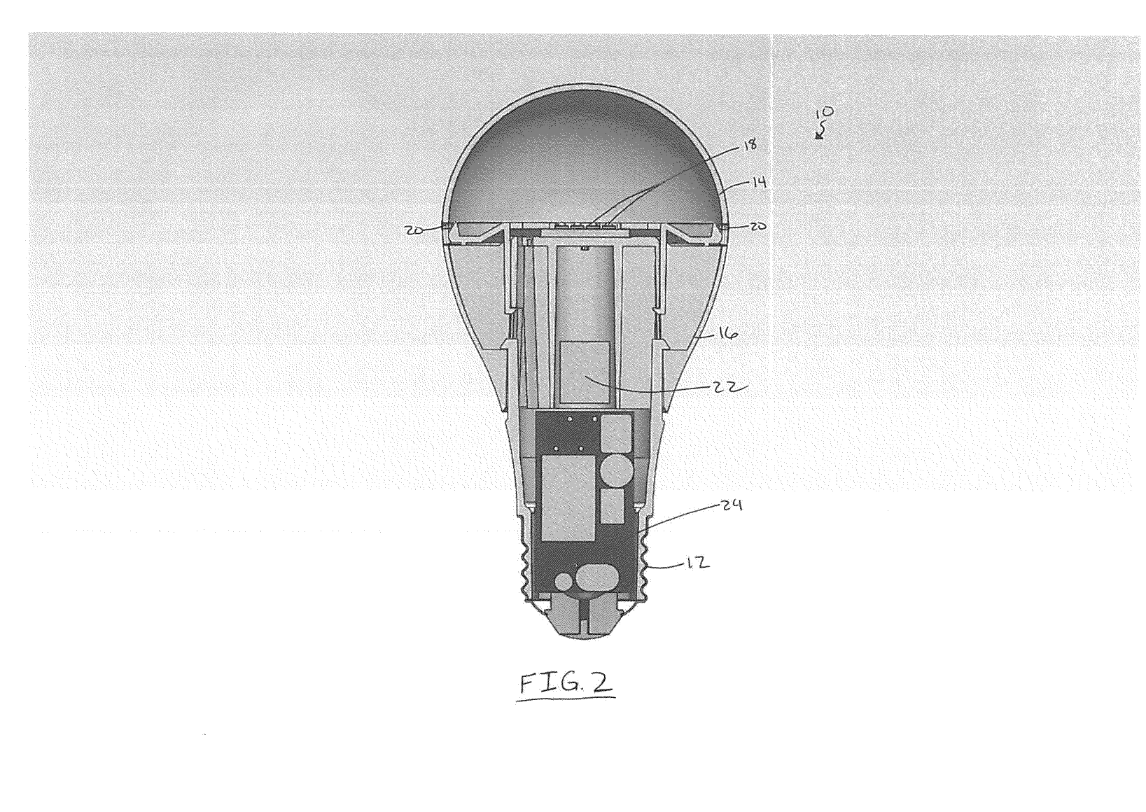

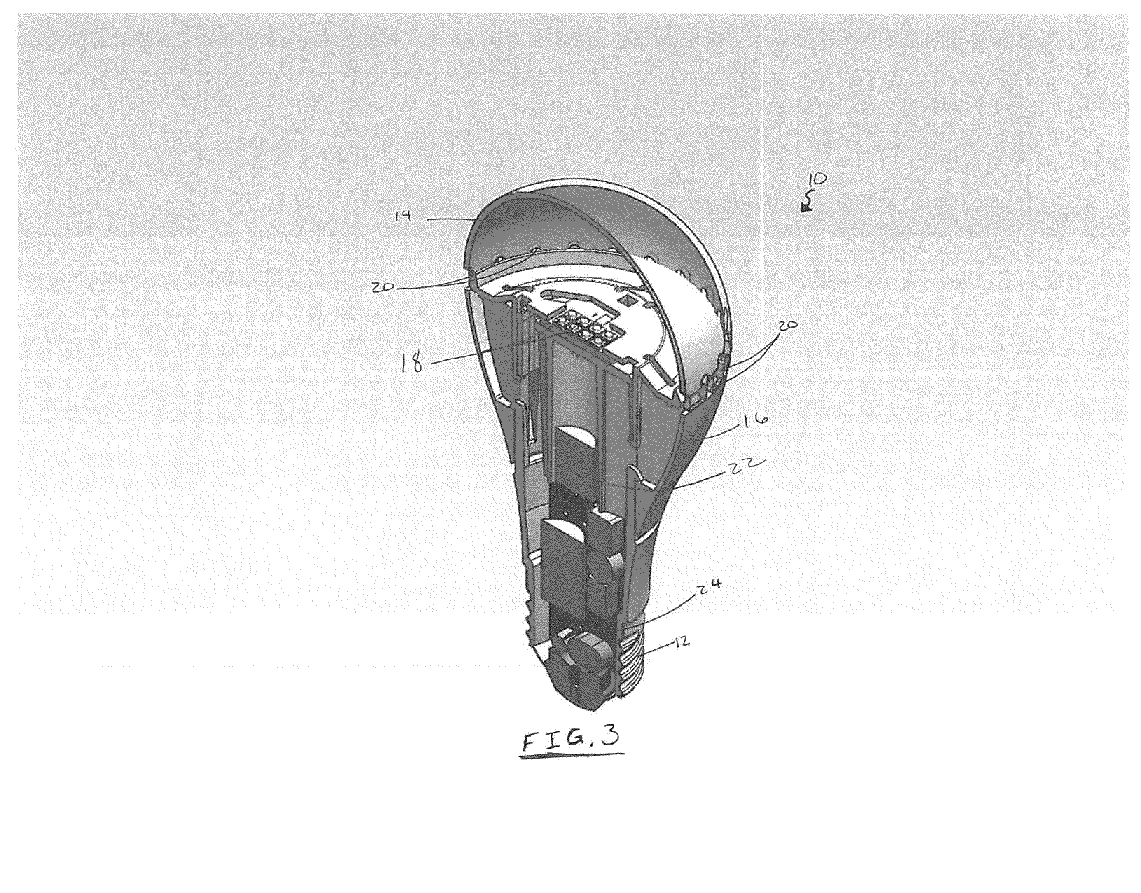

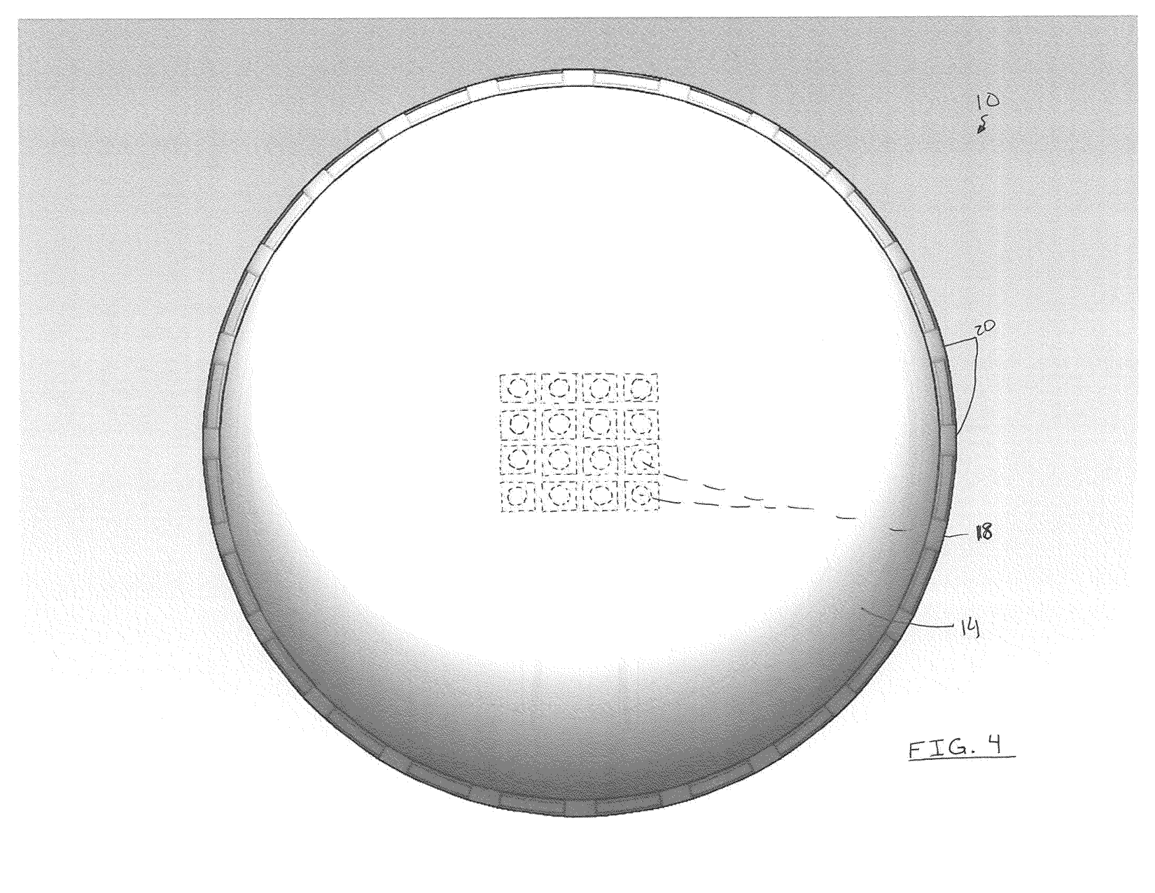

As shown in FIG. 1, the luminaire (or lighting device) 10 may have an electrical base 12, an enclosure 14, and an intermediate member 16 between the electrical base 12 and the enclosure 14. The enclosure may include a plurality of vents 20, which may facilitate passive cooling of the luminaire 10. Referring now additionally to FIGS. 2 and 3, additional details of the luminaire illustrated in FIG. 1 are now discussed. More specifically, a driver circuit 24 and a controller 22 may be in electrical communication with the electrical base 12, and may be housed within the intermediate member 16. A light source 18 may be included within the enclosure adjacent to the intermediate member, and may be in electrical communication with the electrical base 12. Although the light source 18 is illustrated (and perhaps best shown in FIG. 4) as a plurality of lighting devices in an array, the light source 18 may be a single lighting device, or a plurality of lighting devices in any number of configurations, as will be discussed below.

The plurality of vents 20 around the circumference of the enclosure 14 may help to direct heated fluid away from the light source 18, and will be discussed in greater detail below. Although the plurality of vents 20 are here illustrated as being about the circumference of the enclosure 14, it is contemplated that the plurality of vents may be configured in other manners as well. This will be readily apparent to a skilled artisan having had the benefit of this disclosure, and will be demonstrated below. Although the plurality of vents 20 are illustrated as being symmetrically spaced apart along the circumference of the enclosure 14, those skilled in the art will appreciate that any configuration of the vents may be used to carry out the many features, advantages and objects of the present invention. Further, the vents 20 are illustrated as having an inverse “U” shape. This shape advantageously provides ease of manufacturing, as well as increased cost efficiency. Those skilled in the art will appreciate, however, that the vents 20 may have any shape while still carrying out the many features, advantages and objects of the present invention. For example, it is contemplated that the vents 20 may have a substantially circular shape, an ovular shape, a rectangular shape, a polygonal shape, or any other shape suitable for allowing air to flow within the enclosure 14 to provide passive cooling features to the light source 18.

Referring now to FIG. 4, still additional details of the luminaire 10 according to an embodiment of the present invention are now provided and, more specifically, the types of light sources 18 that may be used in connection with the luminaire 10 will be discussed in greater detail. Although LEDs have been mentioned specifically for use as the light source 18 within the enclosure 14, it is contemplated that any light source 18 may be used if it may benefit from the circulation provided by the plurality of vents 20. These potential light sources 18 include, but are not necessarily limited to, standard light bulbs, CFL bulbs, semiconductor lighting devices, LEDs, infrared lighting devices, or laser-driven light sources 18. Additionally, more than one type of lighting device may be used to provide the light source(s) 18.

A conversion coating may be applied to the light source 18 or enclosure 14 to create a desired output color. The inclusion of a conversion coating may advantageously allow the luminaire 10 of the present invention to include high efficiency LEDs, increasing the overall efficiency of the luminaire 10 according to an embodiment of the present invention. Additionally, conversion coatings may be applied, such as a conversion phosphor, delay phosphor, or quantum dot, to condition or increase the light outputted by the light source 18. Additional details of such conversion coatings are found in U.S. patent application Ser. No. 13/357,283 titled Dual Characteristic Color Conversion Enclosure and Associated Methods, filed on Jan. 24, 2012, as well as U.S. patent application Ser. No. 13/234,371 titled Color Conversion Occlusion and Associated Methods, filed on Sep. 16, 2011, and U.S. patent application Ser. No. 13/234,604 titled Remote Light Wavelength Conversion Device and Associated Methods, the entire contents of each of which are incorporated herein by reference.

An example of the inclusion of a conversion coating will now be provided, without the intention to limit the luminaire 10 of the present invention. In this example, the source wavelength range of the light generated by the light source 18 may be emitted in a blue wavelength range. However, a person of skill in the art, after having the benefit of this disclosure, will appreciate that LEDs capable of emitting light in any wavelength ranges may be used in the lighting source 18, in accordance with this disclosure of the present invention. A skilled artisan will also appreciate, after having the benefit of this disclosure, additional light generating devices that may be used in the light source 18 that may be capable of creating an illumination.

Continuing with the present example of the light source 18 with a conversion coating applied, the light source 18 may generate a source light with a source wavelength range in the blue spectrum. The blue spectrum may include light with a wavelength range between 400 and 500 nanometers. A source light in the blue spectrum may be generated by a light emitting semiconductor that is comprised of materials that may emit a light in the blue spectrum. Examples of such light emitting semiconductor materials may include, but are not intended to be limited to, zinc selenide (ZnSe) or indium gallium nitride (InGaN). These semiconductor materials may be grown or formed on substrates, which may be comprised of materials such as sapphire, silicon carbide (SiC), or silicon (Si). A person of skill in the art will appreciate that, although the preceding semiconductor materials have been disclosed herein, any semiconductor device capable of emitting a light in the blue spectrum is intended to be included within the scope of the present invention.

The conversion coating may be a phosphor substance, which may be applied to the blue LEDs. The phosphorous substance may absorb wavelength ranges of emitted by the LEDs and emit light defined in additional wavelength ranges when energized. Energizing of the phosphor may occur upon exposure to light, such as the source light emitted from the light source 18. The wavelength of light emitted by a phosphor may be dependent on the materials from which the phosphor is comprised.

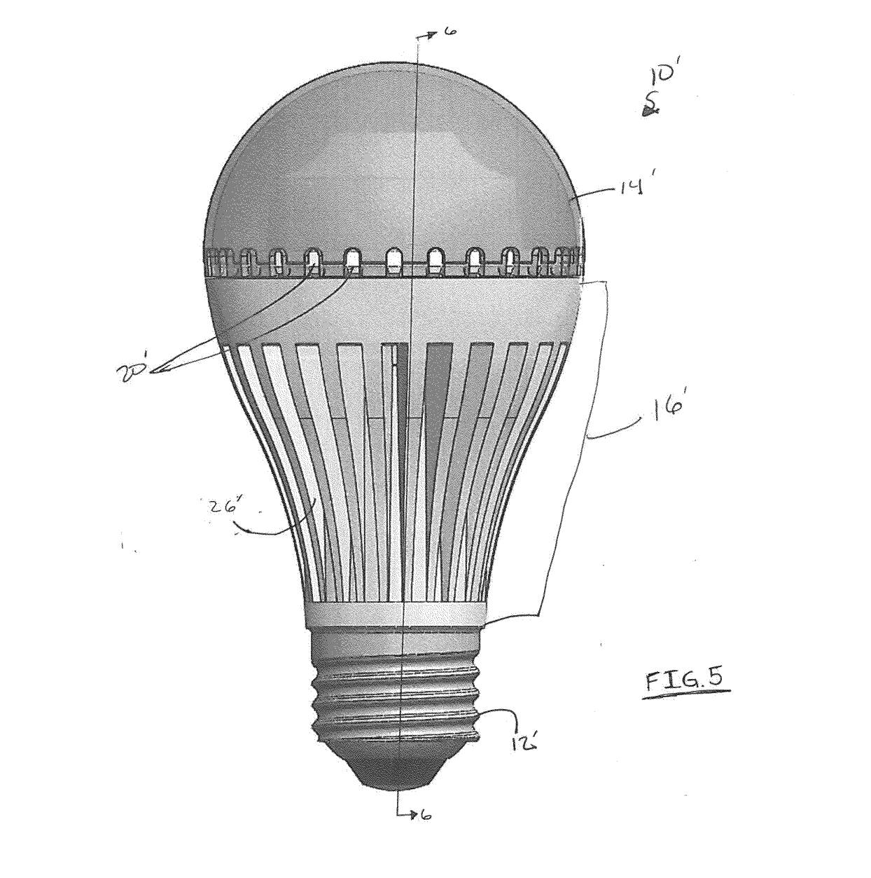

Referring now to FIGS. 5-8, an alternate embodiment of the luminaire 10′ of the present invention will now be discussed. Referring specifically to FIG. 5, a luminaire 10′ having a heat sink 26′ is illustrated. The luminaire 10′ may have an electrical base 12′, an enclosure 14′ having a plurality of vents 20′, and an intermediate member 16′ between the electrical base 12′ and the enclosure 14′. The heat sink 26′ may be positioned adjacent the intermediate member 16′, or, in some embodiments, be included in the intermediate member 16′.

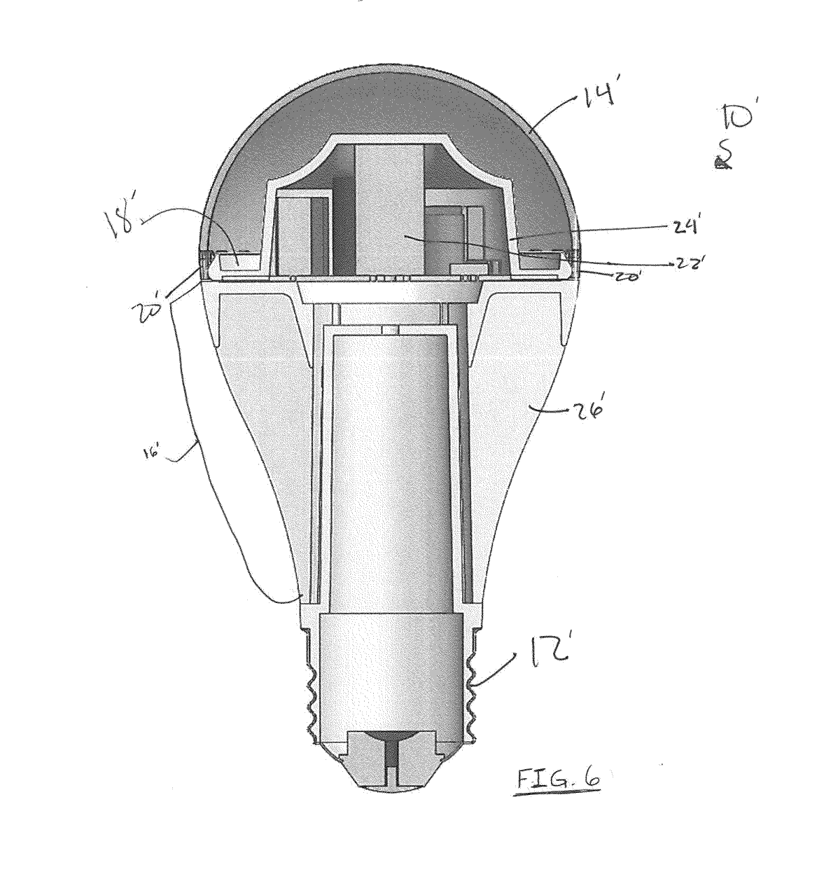

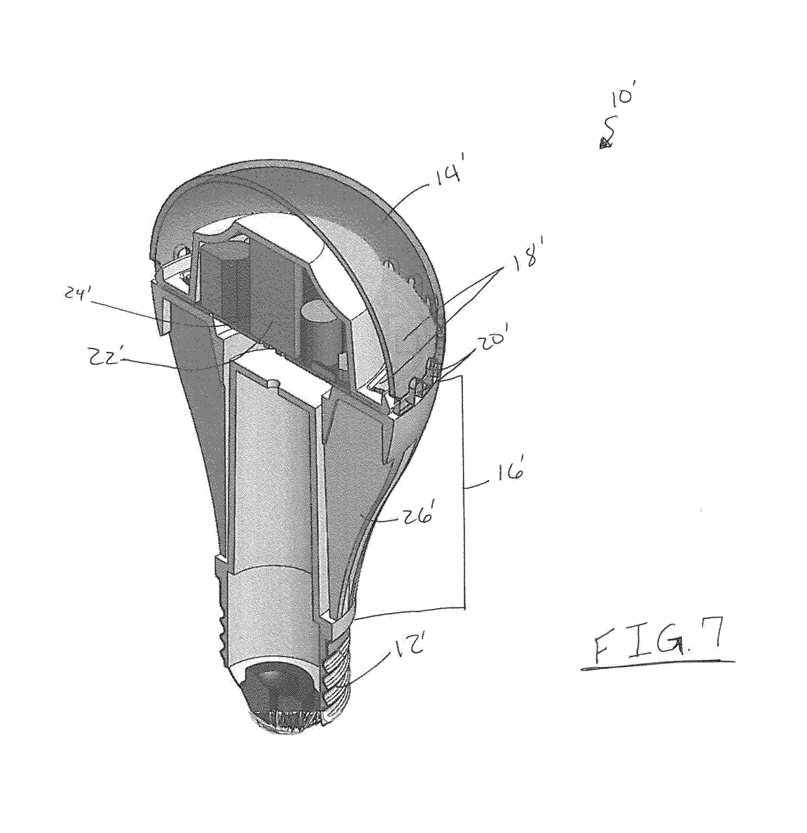

As illustrated in FIG. 6, and additionally in FIG. 7, light source(s) 18′ may be included within the enclosure 14′ and be in electrical communication with the electrical base 12′. The driver circuit 24′ and controller 22′ may also be housed in the enclosure 14′, and in electrical communication with the electrical base 12′. This configuration may be particularly advantageous, as the light source 18′, the driver circuit 24′, and the controller 22′ may benefit from the cooling effects of both the plurality of vents 20′ and the heat sink 26′ as shown in FIGS. 6 and 7. Other configurations may readily present themselves to such skilled artisans having had the benefit of this disclosure, and are intended to be included within the scope and spirit of the present invention.

Heat sinks 26′ function by allowing heat from a heat source to be dissipated over a larger surface area. For this reason, ideal heat sinks 26′ may be made of materials having high heat conductivity. High heat conductivity may allow the heat sink 26′ to readily accept heat from a heat source, cooling the heat source faster than the surface area of the heat source alone. Accordingly, this embodiment of the luminaire 10′ advantageously utilizes a combination of the heat sink 26′ and an enclosure 14′ having vents 20′ formed therein to dissipate heat.

Referring now to FIG. 8, the plurality of vents 20′ of this embodiment of the luminaire 10′ according to the present invention will be discussed in greater detail. The plurality of vents 20′ may be placed around the enclosure 14′ in a circumferential fashion, which may be particularly advantageous if light sources 18′ are also arranged in a circumferential fashion. The plurality of vents 20′ may, of course, be placed in any number of configurations, as may be readily recognized by a skilled artisan having had the benefit of this disclosure, and are not intended to be limited to the examples herein. The plurality of vents 20′ may allow a fluid, such as air, to circulate through the enclosure 14′, cooling the light sources 18′ and/or the driver circuit 24′. As discussed above, the light source(s) 18′ may be any number or type of light source 18′ and is not intended to be limited to the semiconductor lighting devices shown. Additionally, the light source(s) 18′ and/or the enclosure 14′ may include a color conversion coating. Such coatings have been discussed at length above, and require no further discussion herein. The other features of the luminaire 10′ not specifically mentioned herein are similar to those discussed above with respect to the first embodiment of the luminaire 10, are illustrated with prime notation, and require no further discussion herein.

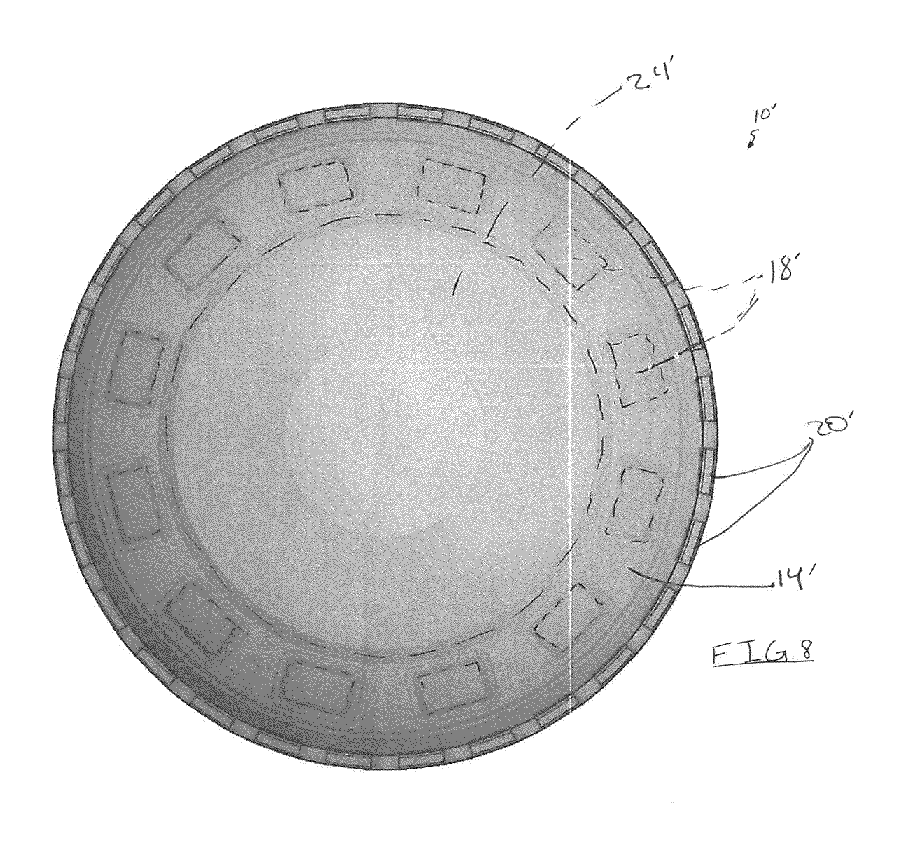

Referring now to FIGS. 9-12, another alternate embodiment of the luminaire 10″ of the present invention will now be discussed. As perhaps best illustrated in FIG. 9, the enclosure 14″ need not necessarily be placed on the end of the luminaire 10″. Additionally, the heat sink 26″ may be positioned between the enclosure 14″ and the intermediate member 16″. The intermediate member 16″ may still be adjacent to the electrical base 12″. Further, the plurality of vents 20″ may be internally formed as a plurality of vents 20″, and externally formed as a single vent 20″.

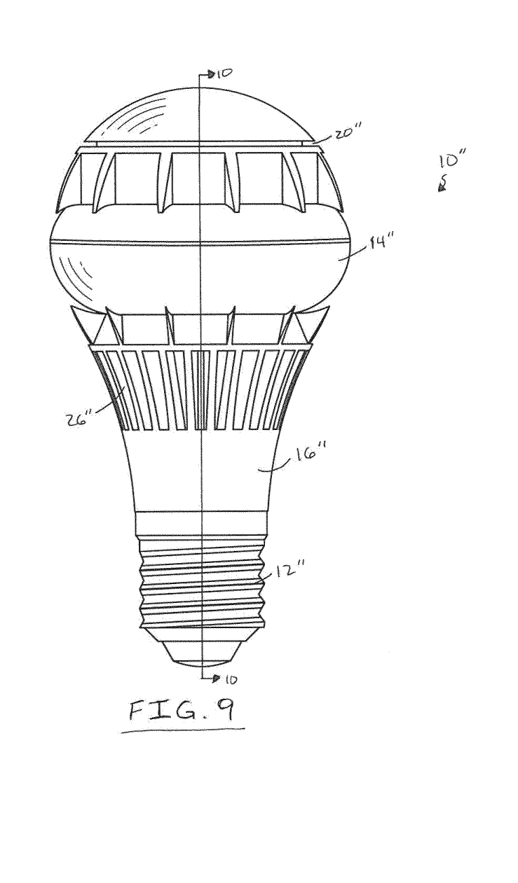

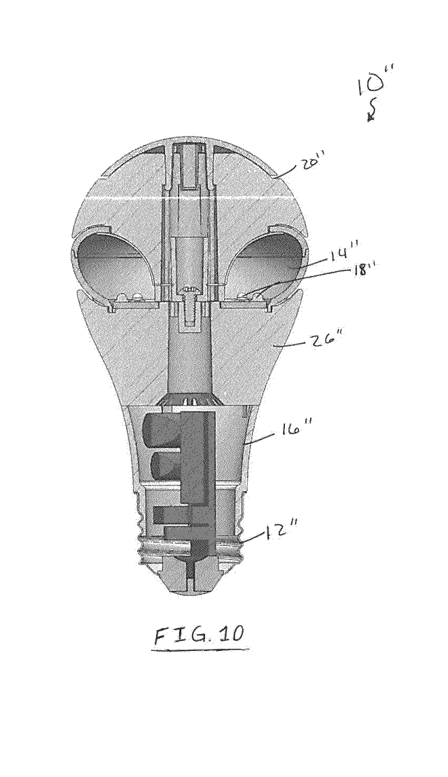

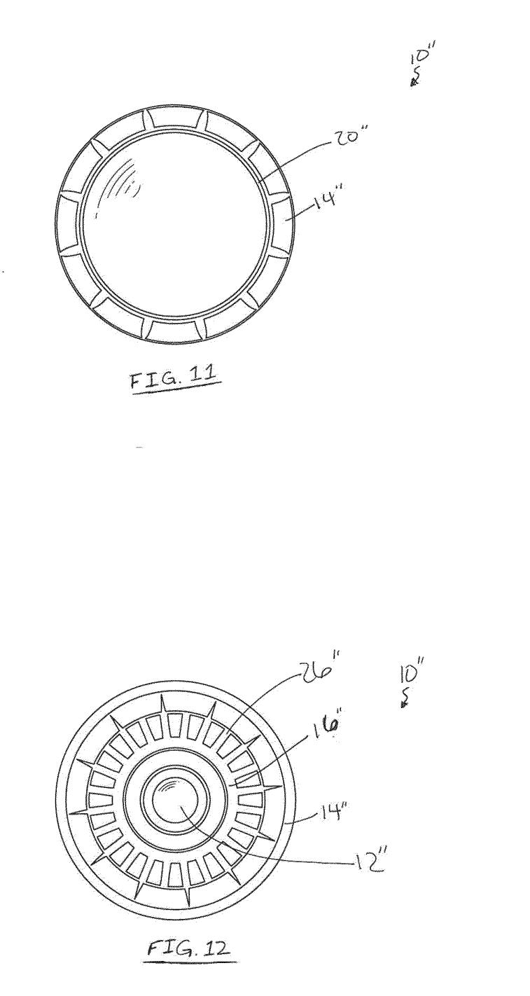

Referring now to FIG. 10, and additionally FIGS. 11 and 12, the embodiment illustrated in FIG. 9 will be discussed further. The light source(s) 18″ may be included within the enclosure 14″. Additionally, the vent(s) 20″ and the heat sink 26″ may be positioned on either side of the enclosure 14″ to allow for more efficient heat transfer. The intermediate member 16″ may connect the heat sink 26″ and the electrical base 12″. The other features of the luminaire 10″ not specifically mentioned herein are similar to those discussed above with respect to the first embodiment of the luminaire 10, are illustrated with double prime notation, and require no further discussion herein.

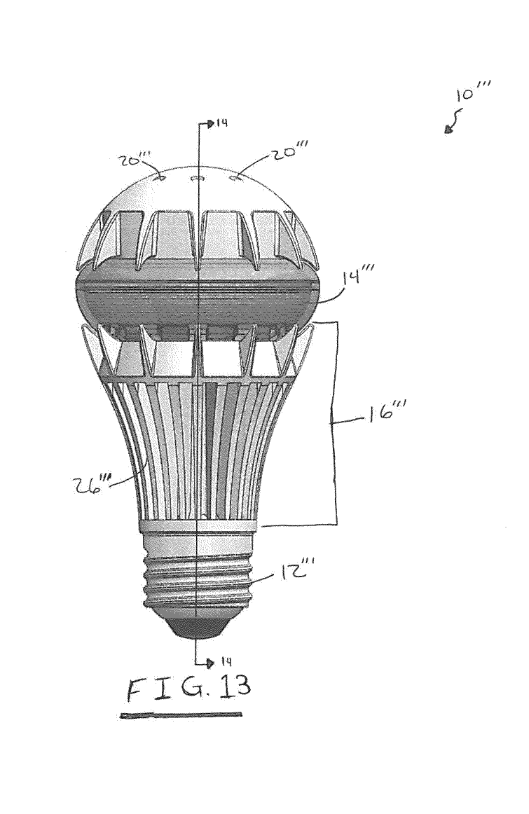

Referring now to FIGS. 13-16, yet another alternate embodiment of the luminaire 10″′ of the present invention will now be discussed. The luminaire 10″′ may include an electrical base 12″′, an intermediate member 16″′ which may include a heat sink 26′″, and an enclosure 14″′ that may include a plurality of vents 20″′, as perhaps best illustrated in FIG. 13. It should be noted that the vents 20″′ may be located at the end of the luminaire 10′″ opposite the electrical base 12″′ as well as the other configurations discussed above. Many additional configurations of the vents 20″′ may come to mind of one skilled in the art having had the benefit of this disclosure, including vents that may pass through the luminaire 10″′ to be adjacent to the electrical base 12″′, and are intended to be included within the scope and spirit of the present invention.

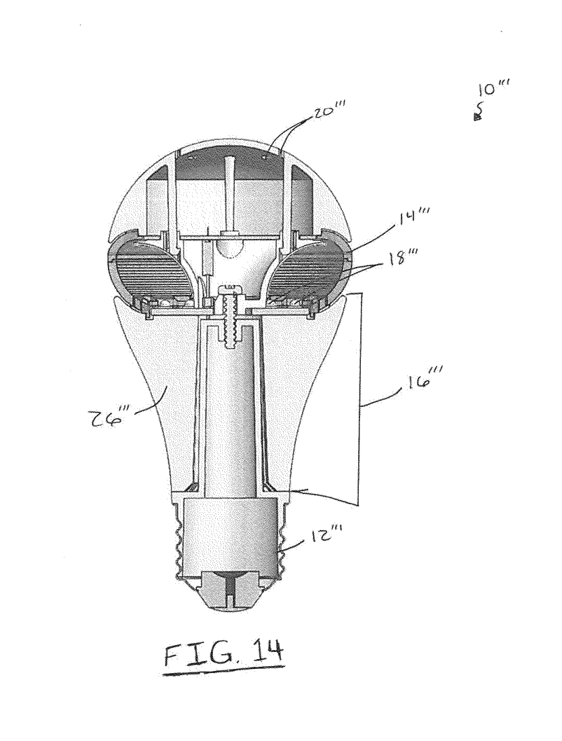

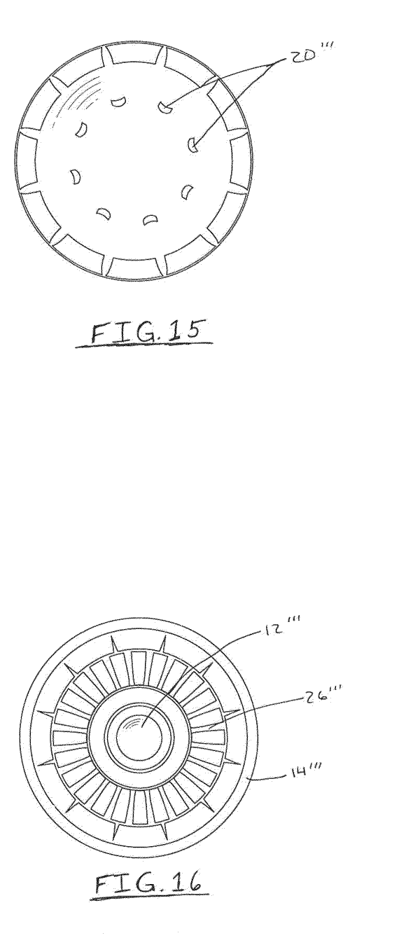

Referring now to FIG. 14, the light source 18″′ is shown in the enclosure 14″′, which is positioned between the plurality of vents 20″′ and the heat sink 26″. The intermediate member 16″′ connects the heat sink 26′″ and the electrical base 12″′ of the luminaire 10″′ according to an embodiment of the present invention. The plan views shown in FIGS. 15 and 16 better illustrate the relative position of the electrical base 12″′, the heat sink 26′″, the enclosure 14″′, and the vents 20″′ on the luminaire 10″′. The configurations disclosed herein are merely exemplary in nature and not intended to be limiting, as many additional embodiments may readily present themselves to skilled persons having had the benefit of this disclosure, and are intended to be included within the scope and spirit of the present invention. The other features of the luminaire 10′″ not specifically mentioned herein are similar to those discussed above with respect to the first embodiment of the luminaire 10, are illustrated with triple prime notation, and require no further discussion herein.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

What is claimed is:

1. A lighting device comprising:
an electrical base;
an enclosure having one or more vents formed therein;
an intermediate member between the electrical base and the enclosure;
a light source adjacent to the intermediate member to be enclosed by the enclosure and positioned in electrical communication with the electrical base;
a controller carried by the intermediate member and positioned in electrical communication with the electrical base;
a driver circuit carried by the intermediate member and positioned in electrical communication with the electrical base; and
wherein the vents are configured to permit a fluid flow through an interior portion of the enclosure so that the light source is in thermal communication with the fluid flow.

2. The lighting device of claim 1 wherein the light source is a plurality of lighting devices.

3. The lighting device of claim 1 wherein the light source is a light-emitting diode.

4. The lighting device of claim 1 wherein the one or more vents are a plurality of vents that are symmetrically spaced around the circumference of the enclosure.

5. The lighting device of claim 1 wherein the one or more vents is a single continuous vent that extends the circumference of the enclosure.

6. The lighting device of claim 1 wherein the shape of each of the one or more vents is an inverse “U”.

7. The lighting device of claim 1 wherein a conversion layer is applied to at least one of the light source, an interior surface of the enclosure and an exterior surface of the enclosure.

8. The lighting device of claim 7 wherein the conversion layer is at least one of a conversion phosphor, delay phosphor, or quantum dot.

9. The lighting device of claim 1 further comprising a heat sink positioned adjacent the intermediate member.

10. The lighting device of claim 9 wherein the intermediate member connects the heat sink and the electrical base.

11. The lighting device of claim 1 wherein the intermediate member comprises a heat sink.

12. A lighting device comprising:
an electrical base;
an enclosure having a plurality of U shaped vents that are symmetrically formed around the circumference of the enclosure;
an intermediate member between the electrical base and the enclosure;
a light source adjacent to the intermediate member;
a controller housed by the intermediate member; and
a driver circuit housed by the intermediate member;
a heat sink between the intermediate member and the enclosure;
wherein the at least one vent is configured to permit a fluid flow through an interior portion of the enclosure; and
wherein the controller and the drive circuit are housed by the intermediate member;
wherein the light source, the driver circuit and the controller are in electrical communication with the electrical base; and
wherein the light source is thermally coupled to the heat sink.

13. The lighting device of claim 12 wherein the at least one or more vents are arranged in a circumferential fashion around the enclosure.

14. The lighting device of claim 12 wherein the shape of the vents is an inverse “U”.

15. The lighting device of claim 12 wherein the intermediate member includes a heat sink.

16. The lighting device of claim 12 further comprising a conversion layer applied to at least one of the light source and the enclosure.

17. The lighting device of claim 12 wherein the light source is positioned in the enclosure between the vents and the heat sink.

18. The lighting device of claim 12 wherein the at least one vent is formed internally as one continuous vent.

19. A lighting device comprising:
an electrical base;
an enclosure having a continuous vent that extends the entire circumference of the enclosure;
an intermediate member between the electrical base and the enclosure;
a light source adjacent to the intermediate member;
a controller housed by the intermediate member;
a driver circuit housed by the intermediate member;
a heat sink between the intermediate member and the enclosure;
wherein the at least one vent is configured to permit a fluid flow through an interior portion of the enclosure; and
wherein the controller and the drive circuit are housed by the intermediate member; and
wherein the light source, the driver circuit and the controller are in electrical communication with the electrical base; and
wherein the light source is thermally coupled to the heat sink.

20. The lighting device of claim 19 wherein the intermediate member includes a heat sink.

21. The lighting device of claim 19 further comprising a conversion layer applied to at least one of the light source and the enclosure.

22. The lighting device of claim 19 wherein the light source is positioned in the enclosure between the vents and the heat sink.
